(19) United States
(12) Patent Application Publication
(10) Pub. No.: US 2024/0228115 A9
(43) Pub. Date: Jul. 11, 2024

(54) Retention System for Articles Packed in a Container for the Transport Thereof and Mounting Tool

(71) Applicant: NEUTROLEADER, S.L.U., Albaida (ES)

(72) Inventor: José Luis Nácher Vañó, Albaida (ES)

(21) Appl. No.: 18/279,688

(22) PCT Filed: Feb. 23, 2022
(86) PCT No.: PCT/ES2022/070096

§ 371 Date: Aug. 31, 2023

(30) Foreign Application Priority Data
Mar. 3, 2021 (ES) P202130178

(51) Int. Cl. B65D 25/10; B25B 27/02; B65D 81/05

(52) U.S. Cl. CPC B65D 25/10; B25B 27/02; B65D 81/057

(57) ABSTRACT

The container has a base and lateral walls. The system of the invention comprises at least one retention support configured to be mounted on an area of the internal surface of the container; where said retention support is in contact with at least part of a body to be secured, which rests on the base of the container. The body to be secured is restrained inside the container on a plane selected from among a horizontal plane parallel to the base of the container, a vertical plane perpendicular to said base of the container, and two perpendicular planes: the horizontal plane parallel to the base of the container and the vertical plane perpendicular to the base of the container.

### CROSS-REFERENCE TO RELATED APPLICATIONS

This application is the United States national phase of International Application No. PCT/ES2022/070096 filed Feb. 23, 2022, and claims priority to Spanish Patent Application No. P202130178 filed Mar. 3, 2021, the disclosures of which are hereby incorporated by reference in their entireties.

### BACKGROUND OF THE INVENTION

### Field of the Invention

The present invention relates to a retention system for articles packed in a container for the transport thereof, which allows securing at least one package inside the container in a simple, quick and practical way; where said package contains within it the article or articles in question to be transported or sent; and where said package can be mounted immovably inside the container in different positions, being able to choose the most convenient position for transporting the article by means of the retention system of the invention. It is also possible to directly secure the article inside the container without the package. The invention further encompasses a mounting tool.

### Description of Related Art

The field of the art in which the present invention is comprised is that belonging to the construction of light modular buildings. More specifically, constructions based on load-bearing metal panels made up of flat sections of aluminum or steel that also fulfil the function of cladding.

Corner pieces used to protect corners are generally known. For example, to protect the corner areas of a pallet load, corner pieces are used that are secured with adhesive tape and then the entire load of the pallet is wrapped with plastic film.

On the other hand, the protection and separation of bodies to be secured located inside a box or container is carried out using different separating means to create departments, grids and other configurations; where each of said bodies to be secured can be a package with an article inside or the article itself that is inserted directly into the container without the package.

For example, polyspan pad elements as well as other loose materials can be placed inside the box as separating means to protect the part or parts housed inside the box. Other separating means that are used are air pillows, as well as filler paper.

At present, many articles are sent in cardboard boxes or containers, so that in most cases the package with the article located inside the box does not fit the interior space of said box, which is why it is necessary to secure it with different means such as, for example, filling the empty spaces with folded paper or other filler elements, such as tiny white cork elements, etc., or the separating means described above.

Therefore, the technical problem to be solved is to be able to adapt the package effectively, simply and practically with the article, inside the box or container so that it remains stable without the possibility of moving during transport and/or shipping, since in most cases the dimensions of the package with the article are not adapted to the internal dimensions of the box or container.

### SUMMARY OF THE INVENTION

In order to achieve the objectives and avoid the drawbacks in the previous sections, the invention proposes a retention system for articles packed in a container for the transport thereof that comprises at least one retention support configured to be mounted on an area of the internal surface of the container; where said retention support is in contact with at least part of a body to be secured selected between a package with the article inside and the article itself which rests on the base of the container.

The body to be secured is restrained inside the container by means of the retention support on a plane selected from among a horizontal plane parallel to the base of the container, a vertical plane perpendicular to said base (1a) of the container, and two perpendicular planes: the horizontal plane parallel to the base of the container and the vertical plane perpendicular to the base of the container.

In a first embodiment of the invention, the system comprises at least one retention support that is mounted on the base of the container; where an area of the body to be secured is in contact with said retention support, while other areas of the body to be secured are in contact with areas of the lateral walls of the container; and where the retention system restrains the body to be secured in the horizontal plane parallel to the base of the container.

In a second embodiment of the invention, the system comprises at least two retention supports that are mounted in opposition to the base of the container; where the retention system restrains the body to be secured in the horizontal plane parallel to the base of the container between the two retention supports in opposition.

In a third embodiment of the invention, the system comprises at least one retention support that is mounted on one of the lateral walls of the container; where the retention system restrains the body to be secured at least in the vertical plane perpendicular to the base of the container; and where the body to be secured is in contact with at least two adjacent lateral walls of the container.

In a fourth embodiment of the invention, the retention system comprises at least two retention supports: a first one mounted on the base of the container and a second retention support mounted on at least one of the lateral walls of the container; where the retention system restrains the body to be secured in the horizontal plane parallel to the base of the container and in the vertical plane perpendicular to said base.

In a fifth embodiment of the invention, the retention system comprises four retention supports: the first two mounted on the base of the container and two second retention supports mounted on the lateral walls of the container; where the retention system restrains the body to be secured in the horizontal plane parallel to the base of the container and in the vertical plane perpendicular to said base.

In a sixth embodiment of the invention, the system comprises at least one retention support mounted on one of the covers that close a mouth of the container; where the retention system restrains the body to be secured at least in the horizontal plane parallel to the base (1a) of the container.

The retention support comprises a foldable laminar body that includes at least two first flaps attached by means of a first fold line, and two second flaps which are attached to the first flaps by means of second fold lines; where in a folded position of the laminar retention support, the first two flaps are arranged in two planes with an angular offset, while the second flaps are arranged in the same plane with an angular offset with respect to the first flaps; and where the laminar retention support is mounted on the internal surface of the container by means of its two second flaps.

The two second flaps of the laminar retention support are attached to the internal surface of the container by means of an adhesive material that impregnates one of the faces of the second flaps; where this attachment with the adhesive material stably maintains the assembly of the laminar retention support; and where the second flaps are oriented according to a position selected between a first interior position emerging towards the interior space of the retention support, and a second exterior position emerging towards the exterior of the retention support.

The first two flaps of the retention support form an angle selected from among an acute angle, an obtuse angle and a 90° angle.

In one embodiment of the invention, at least one of the first two flaps of the retention support is attached to the internal surface of the container by means of an adhesive material that impregnates one of the two faces of the first flaps.

In one embodiment of the invention, the retention support comprises a foldable laminar body that includes a prismatic-shaped prismatic body and two second flaps that are used to adhere to the Internal surface of the container.

In one embodiment of the invention, the retainer includes cantilevered flaps attached to the first flaps by means of fold lines; where said flaps are folded inwards and are configured so that the body to be secured contacts them when it is restrained inside the container.

The invention also describes a mounting tool that is used to position and mount the retention support on the internal surface of the container in a practical way.

The mounting tool comprises a handle and two symmetrical wings converging at one end of the handle that includes a first gripping section and a second section that is attached to the convergence area of said symmetrical wings.

The handle includes an angular recess along the entire length of its second section, where two internal faces of said angular recess are coplanar with internal edges of the symmetrical fins, while seat faces of the symmetrical fins are located in a coplanar plane that is substantially perpendicular to the entire extension of the angular recess of the handle.

The handle further includes a cantilevered central extension facing an initial part of the angular recess, where said initial part is a prolongation of the first section of the handle; and where said central extension is attached to the first section of the handle.

To help better understand this specification, and as an integral part thereof, a series of figures is attached, in which the object of the invention is depicted in an illustrative and non-limiting manner.

### BRIEF DESCRIPTION OF THE DRAWINGS

The terms Fig., Figs., Figure, and Figures are used interchangeably in the specification to refer to the corresponding figures in the drawings.

FIG. 1 shows a perspective view of the retention system for articles packed in a container for the transport thereof, where a retention support is mounted on the base of said container.

FIG. 2 depicts a plan view of an embodiment of the invention where a parallelepiped package with the article inside is restrained inside the container by means of a single retention support.

FIG. 3 shows a view similar to the previous one, where the package with the article is restrained in the center of the container by means of two retention supports in opposition.

FIG. 4 shows a view similar to the two previous two, where two cylindrical packages are located inside the container, secured by means of respective retention supports.

FIG. 5 shows a view similar to that depicted in FIG. 1, where the package with the article is restrained by means of a first retention support mounted on the base of said container, and a second retention support mounted on a raised area of the lateral walls of said container.

FIG. 6a shows a view of a retention support with a laminar structure in the deployed position.

FIG. 6b shows a perspective view of the retention support of the previous figure in the folded position that presents an angular configuration with second flaps arranged inwardly.

FIG. 6c shows a view similar to that shown in FIG. 6b, where the second flaps are folded outwardly.

FIG. 7 shows a perspective view of the retention system of the invention, where an article, such as a roll of paper, is restrained directly inside the container by means of two retention supports.

FIG. 8 shows a perspective view of the retention system of the invention, where a package with the article inside is restrained inside the container.

FIG. 9 shows a view similar to that shown in FIG. 7, where the article is a diffuser and is restrained by four retention supports.

FIG. 10 shows a perspective view of an open container that has a mouth closed with covers; where a retention support that participates in restraining a body secured inside the container, either an article directly or a package with the article inside, is mounted on one of said covers.

FIG. 11 shows a perspective view of a mounting tool for mounting the retention supports on the internal surface of the container.

FIG. 12 shows a perspective view of the mounting tool with the retention support placed on said mounting tool.

FIG. 13 shows another perspective view similar to that shown in FIG. 12.

### DESCRIPTION OF THE INVENTION

Considering the numbering used in the figures, the retention system for articles packed in a container 1 for transport thereof comprises at least one retention support 2 configured to be attached to at least one strategic area of the base 1a of the container 1 in order to secure a package 3 in which the article in question is housed, where the retention support 2 is responsible for securing the package 3 inside the container 1 to prevent shifting in planes parallel to the base 3a of said package 3.

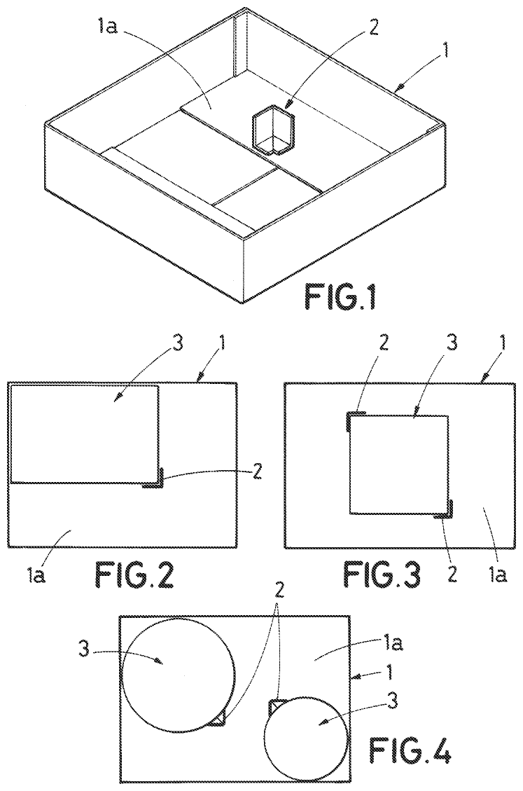

In FIGS. 1, 2 and 4, the system of the invention uses a single retention support 2, so that the package 3 in question rests on the base 1a of the container 1, while some parts of the lateral walls of the package 3 rest on pairs of lateral walls 1b of the container 1 and other parts of the lateral walls of the package 3 abut against the retention support 2.

In FIG. 3, the package 3 is substantially restrained in a central area of the interior space of the container 1, so that in this case the package 3 has a parallelogram-shaped plan configuration and is secured by two retention supports 2 located in coincidence with the ends of a diagonal of the base of the package 3.

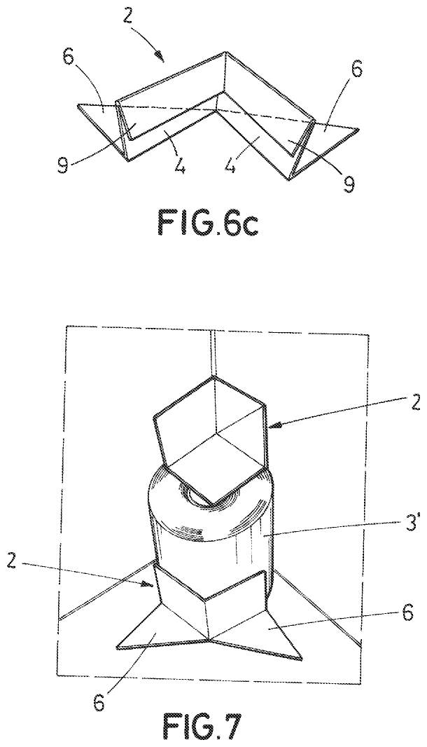

In one embodiment of the invention as shown more clearly in FIGS. 6a, 6b and 6c, the retention support 2 comprises a foldable laminar body that includes at least two first flaps 4 attached by means of a first fold line 5, and two second flaps 6 that are attached to the first flaps 4 by means of second fold lines 7.

In line with what is stated in the preceding paragraph, in the unfolded position, the laminar retention support 2 presents a flat configuration as shown in FIG. 6a. On the other hand, in the folded position of use of the laminar retention support 2 as shown in FIGS. 6b, 6c, the first two flaps 4 are arranged in two planes with an angular offset of substantially 90°, while the second flaps 6 are arranged in the same plane with an angular offset of substantially 90° with respect to the first flaps 4.

Obviously, both 90° offsets can have a different angular amplitude, both greater and lesser; all of this will depend on the need to adapt the retention support 2 with respect to the body to be secured inside the container 1.

Thus, the retention support 2 described in the two preceding paragraphs is attached to the base of the container 1 by means of the two second flaps 6 by means of adhesive that impregnates one of its faces; where this attachment with the adhesive material stably maintains the assembly of the laminar retention support 2, with the first two flaps 4 emerging upwards at an angle with respect to the base 1a of the container 1.

The adhesive material of the second flaps 6 can be applied from the outside through a metering device, and in another embodiment like the one shown in the figures, the adhesive is already incorporated on the second flaps 6 themselves, protected by means of protective sheets 8 that are previously detached to be able to attach the retention supports on the base of the container 1. The retention support 2 could even be mounted by means of staples, for example.

On the other hand, it should be noted that the angular configuration formed by the first two flaps 4 of the retention support 2 in the folded position of use, said configuration could be different. It should also be noted that the system of the invention can also secure packages 3 with a cylindrical shape; where in this case the lateral wall with a circular contour of the package 3 would rest, for example, on two adjacent lateral walls 1b of the container 1, and in another area of said lateral wall 1b it would be in contact with the first flaps 4 of the retention support 2.

Thus, in a first embodiment of the invention there is attached on the base 1a of the container a retention support 2 which retains the package 3 (packaging) in a horizontal plane against the lateral walls of the container 1; in a second embodiment there are attached on the base 1a of the container at least two retention supports 2 which retain the package 3 in a horizontal plane between these two retention supports 2; and in a third embodiment of the invention there is attached at least one retention support 2 on a lateral wall 1b of the container 1 to prevent movement in two planes, horizontal (parallel to the base of the container 1) and vertical; where in this third embodiment the retention support 2 is attached to the lateral wall 1b of the container 1, close to its mouth.

It is possible for the retention support 2 mounted on the lateral wall 1b of the container 1 to restrain the package only in the vertical direction.

The system of the invention also provides for the possibility of using the combination of at least one retention support 2 mounted on the base 1a of the container 1, and at least one retention support 2 mounted on at least one of the lateral walls 1b of said container. 1.

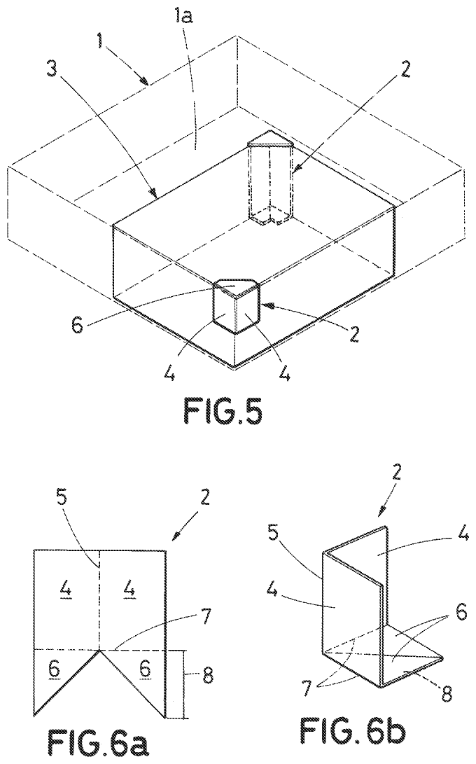

Thus, in line with what was said in the preceding paragraph and as shown in FIG. 5, the package 3 can also be restrained inside the container 1 by means of a first retention support 2 mounted on the base 1b of the container 1 and by means of a second retention support 2 mounted in a raised area of one of the corners where two adjacent lateral walls 1b of said container 1 converge. The second support 2 also comprises the first two flaps 4 that form an angle of substantially 90° between them and a second flap 6 that forms an angle of 90° with respect to the other two first flaps 4, so that in this case the adhesive material for mounting said second support 2 on the container 1 is impregnated on one of the faces of the first flaps 4.

In reference to FIG. 5, the first retention support 2 has the height of the package 3 that it secures, at the same time that it includes a second flap 6 as the second flap 6 of the second retention support 2, so that both second flaps 6 are in contact with an upper base of the package 3. Another option is for the first retention support 2 to be like the one shown in FIG. 1.

The retention support 2 shown in FIG. 6c includes cantilevered flaps 9 attached to the first flaps 4 by means of fold lines; where said flaps are folded inwards and on which the body to be secured 3, 3′ contacts when it is restrained inside the container 1; where said flaps 9 can have a soft damping function of the body to be secured 3, 3′.

FIG. 7 shows an article 3′, such as a roll of paper, which is restrained directly inside the container 1 by means of a first retention support 2 mounted on the base 1a of the container 1, and by means of a second retention support 2 mounted on a corner area where two contiguous lateral walls 1b of said container 1 meet.

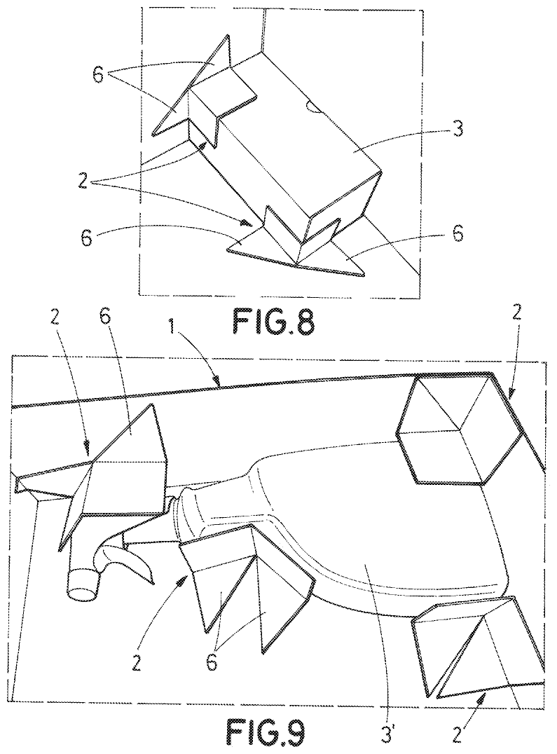

FIG. 8 shows a package 3 restrained by means of a first retention support 2 mounted on the base 1a of the container 1 and by means of a second retention support 2 mounted on a lateral wall 1b of the container.

FIG. 9 shows an article 3′, such as a diffuser container, which is restrained directly inside the container 1 by means of four retention supports: the first two mounted on the base 1a of the container 1 and two second retention supports mounted on the lateral walls 1b of the container; where one of these last two has a prismatic-shaped configuration that is mounted in the area of confluence of two adjacent lateral walls 1b of the container 1.

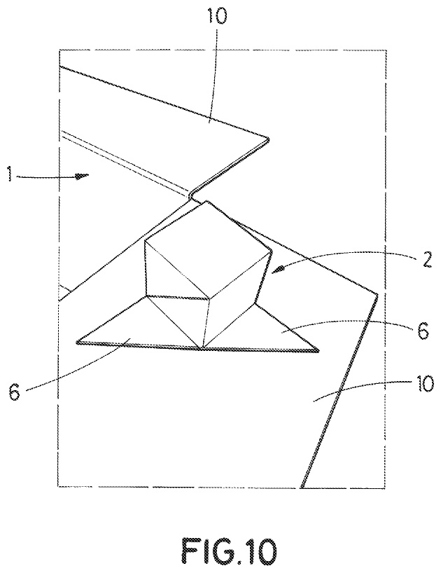

FIG. 10 shows an open container 1 that has a mouth closed with covers 10; where there is mounted on one of said covers 10 a cube-shaped retention support 2 that participates in restraining a body to be secured inside the container 1, either an article 3′ directly or a package 3 with the article inside. In one embodiment of the invention, said cube-shaped retention support 2 includes second flaps 6 to be able to be attached to the cover 10 of the container 1. However, the retention support 2 that is mounted on the cover 10 could have the configuration of the other retention supports 2 described.

The retention support 2, such as the one shown in FIG. 6c, adapts to the required height of the body to be secured 3, 3′ covering the clearance section between the upper part of the body to be secured 3, 3′ within of the container 1 and its covers 10, so that the retention support 2 can be located on the package 3 itself or in the upper part of the container 1, such as on one of its covers 10.

Said retention support 2 can be placed as is or if the clearance section is less than the height of the first flaps 4 of the retention support 2, then this height is reduced by folding the flaps 9 along other fold lines in accordance with said height.

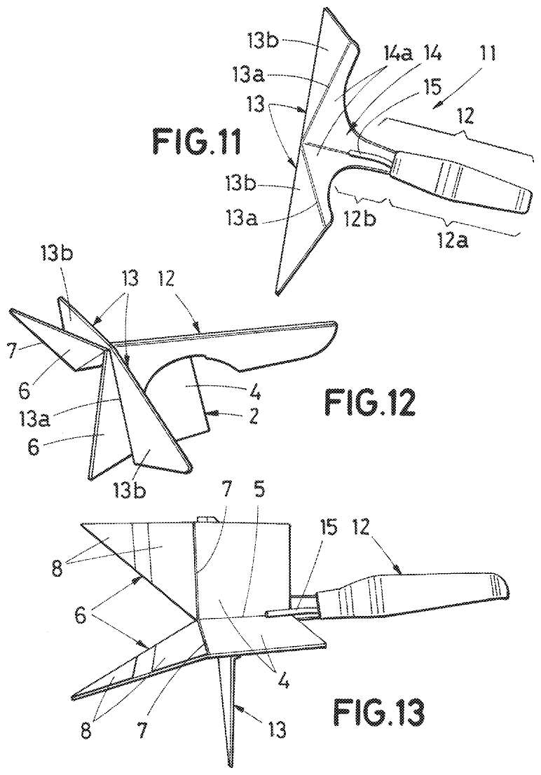

FIGS. 11 and 12 show a mounting tool 11 that can be used to place the retention support more practically 2 on the internal surface of the container 1. For this purpose, the mounting tool 11 comprises a handle 12 and two symmetrical wings 13 converging at one end of the handle 12 that includes a first gripping section 12a and a second section 12b that is attached to the convergence area of said symmetrical wings 13.

The handle 12 includes an angular recess 14 along the entire length of its second section 12b, such that two internal faces 14a of said angular recess 14 are coplanar with internal edges 13a of the symmetrical wings 13, while seat faces 13b of the symmetrical wings 13 are located in a coplanar plane that is substantially perpendicular to the entire extension of the angular recess 14 of the handle 12.

The handle 12 further includes a cantilevered central extension 15 facing an initial part of the angular recess 14, where said initial part is a prolongation of the first section 12a of the handle 12; and wherein said central extension 15 is attached to the first section 12a of the handle 12.

The application of the mounting tool 11 is as simple as that shown in FIGS. 11 and 12, so that the first two angled flaps 4 of the retention support 2 are placed resting on the internal faces 14a of the angular recess 14 and on the inner edges 13a of the symmetrical wings 13. In this situation, an angular portion configured by the first two flaps 4 ensures their securing by means of the central extension 15 (FIG. 13). Finally, the second flaps 6 of the retention support 2 are folded down slightly, bringing them closer to the seat faces 13b of the two symmetrical flaps 13. Finally, all that remains is to place the adherent surfaces of the second flaps 6 on the required area of the internal surface of the container 1 and press with the mounting tool 11 on the two second flaps 6.

Normally the retention support 2 is a laminar body made of cardboard material, although it can also comprise a rigid angled body made of another material, where in this case it also includes its adhesive area to be able to be attached on the corresponding area of the interior surface of the container 1.

As previously mentioned, with two retention supports 2 it is possible, once placed in the base 1a of the container 1, to retain the package 3 (packaging) even in the center of said container 1.

With this solution of the retention system of the invention, the “Ecommerce” so fashionable today, now takes a step forward in efficiency and respect for the environment, in addition to the improvement that involves retaining the package 3 with the purchased product/article inside its shipping container.

On the other hand, although the retention support 2 described has been specifically designed to constitute an independent part of the package or container, it cannot be ruled out that it can be materialized directly by means of a die-cutting in the sheet itself of said container 1, such as coinciding with a flap or a lateral wall of said container, so that it can be mounted by pressing it inwards. Although this avoids the use of gluing means, it limits the versatility in placement by covering fewer dimensions.

1. A retention system for articles packed in a container for the transport thereof, where the container comprises a base and lateral walls, the retention system comprising:
at least one retention support configured to be mounted on an area of the internal surface of the container; where said retention support is in contact with at least part of a body to be secured, selected between a package with the article inside and the article itself which rests on the base of the container;
wherein the body to be secured is restrained inside the container by means of the retention support on a plane selected from among a horizontal plane parallel to the base of the container, a vertical plane perpendicular to said base of the container, and two perpendicular planes: the horizontal plane parallel to the base of the container and the vertical plane perpendicular to the base of the container.

2. The retention system for articles packed in a container for the transport thereof according to claim 1, wherein the system comprises at least one retention support that is mounted on the base of the container; wherein an area of the body to be secured is in contact with said retention support, while other areas of the body to be secured are in contact with areas of the lateral walls of the container;
wherein the retention system restrains the body to be secured in the horizontal plane parallel to the base of the container.

3. The retention system for articles packed in a container for the transport thereof according to claim 1, wherein the system comprises at least two retention supports that are mounted in opposition to the base of the container; wherein the retention system restrains the body to be secured in the horizontal plane parallel to the base of the container between the two retention supports in opposition.

4. The retention system for articles packed in a container for the transport thereof according to claim 1, wherein the system comprises at least one retention support that is mounted on one of the lateral walls of the container; where the retention system restrains the body to be secured at least in the vertical plane perpendicular to the base of the container; and where the body to be secured is in contact with at least two adjacent lateral walls of the container.

5. The retention system for articles packed in a container for the transport thereof according to claim 1, wherein the system comprises at least two retention supports: a first one mounted on the base of the container and a second retention support mounted on at least one of the lateral walls of the container; where the retention system restrains the body to be secured in the horizontal plane parallel to the base of the container and in the vertical plane perpendicular to said base.

6. The retention system for articles packed in a container for the transport thereof according to claim 1, wherein the system comprises four retention supports: the first two mounted on the base of the container, and two second retention supports mounted on the lateral walls of the container; where the retention system restrains the body to be secured in the horizontal plane parallel to the base of the container and in the vertical plane perpendicular to said base.

7. The retention system for articles packed in a container for the transport thereof according to claim 1, wherein the system comprises at least one retention support mounted on one of the covers that close a mouth of the container; where the retention system restrains the body to be secured at least in the horizontal plane parallel to the base of the container.

8. The retention system for articles packed in a container for the transport thereof according to claim 1, wherein the retention support comprises a foldable laminar body that comprises at least two first flaps attached by means of a first fold line, and two second flaps which are attached to the first flaps by means of second fold lines; where, in a folded position of the laminar retention support, the first two flaps are arranged in two planes with an angular offset, while the second flaps are arranged in the same plane with an angular offset with respect to the first flaps; and where the laminar retention support is mounted on the internal surface of the container by means of its two second flaps.

9. The retention system for articles packed in a container for the transport thereof according to claim 8, wherein the two second flaps of the laminar retention support are attached to the internal surface of the container by means of an adhesive material that impregnates one of the faces of the second flaps; where this attachment with the adhesive material stably maintains the assembly of the laminar retention support; and where the second flaps are oriented according to a position selected between a first interior position emerging towards the interior space of the retention support, and a second exterior position emerging towards the exterior of the retention support.

10. The retention system for articles packed in a container for the transport thereof according to claim 8, wherein the first two flaps of the retention support form an angle selected from among an acute angle, an obtuse angle and a 90° angle.

11. The retention system for articles packed in a container for the transport thereof according to claim 10, wherein at least one of the first two flaps of the retention support is attached to the internal surface of the container by means of an adhesive material that impregnates one of the two faces of the first flaps.

12. The retention system for articles packed in a container for the transport thereof according to claim 1, wherein the retention support comprises a foldable laminar body that comprises a prismatic-shaped prismatic body and two second flaps.

13. The retention system for articles packed in a container for the transport thereof according to claim 8, wherein the retention support comprises cantilevered flaps attached to the first flaps by means of fold lines; where said flaps are folded inwards and are configured so that the body to be secured contacts them when it is restrained inside the container.

14. A mounting tool which, configured to place and mount the retention support of claim 1, said mounting tool comprising:
a handle and two symmetrical wings converging at one end of the handle that comprises a first gripping section and a second section that is attached to the convergence area of said symmetrical wings;
the handle comprises an angular recess along the entire length of its second section, where two internal faces of said angular recess are coplanar with internal edges of the symmetrical wings, while seat faces of the symmetrical wings are located in a coplanar plane that is substantially perpendicular to the entire extension of the angular recess of the handle;
the handle further comprises a cantilevered central extension facing an initial part of the angular recess, where said initial part is a prolongation of the first section of the handle; and wherein said central extension is attached to the first section of the handle.
